(19) United States
(12) Patent Application Publication
(10) Pub. No.: US 2006/0031561 A1
(43) Pub. Date: Feb. 9, 2006

(54) Methods for controlling a distributed computing environment and data processing system readable media for carrying out the methods

(75) Inventors: Thomas P. Bishop, Austin, TX (US); Ashwin Kamath, Cedar Park, TX (US); Peter Anthony Walker, Cedar Park, TX (US); Timothy L. Smith, Austin, TX (US)

Correspondence Address: TOLER & LARSON & ABEL L.L.P., 5000 PLAZA ON THE LAKE STE 265, AUSTIN, TX, 78746, US

(73) Assignee: VIEO, Inc.

(21) Appl. No.: 10/881,078

(22) Filed: Jun. 30, 2004

(51) Int. Cl. G06F 15/16

(52) U.S. Cl. 709/232

(57) ABSTRACT

A system and method is provided for controlling a distributed computing environment. The distributed computing environment is controlled by controlling flows, streams, and pipes used by applications within the distributed computing environment. The controls on each of the flows, streams, and pipes include latency, priority, a connection throttle, and a network packet throttle. Parameters for determining the values for each of the controls are based on any one or more of Virtual Local Area Network Identifier (VLAN ID), source address, destination address, source port, destination port, protocol, connection request, and transaction type load tag.

### CROSS-REFERENCE TO RELATED APPLICATION(S)

This application is related to U.S. patent application Ser. No. 10/761,909, entitled: “Methods and Systems for Managing a Network While Physical Components are Being Provisioned or De-provisioned” by Thomas Bishop et al., filed on Jan. 21, 2004. This application is further related to U.S. patent application Ser. No. 10/826,719, entitled: “Method and System For Application-Aware Network Quality of Service” by Thomas Bishop et al., filed on Apr. 16, 2004. This application is even further related to U.S. patent application Ser. No. 10/826,777, entitled: “Method and System For an Overlay Management System” by Thomas Bishop et al., filed on Apr. 16, 2004. All applications cited within this paragraph are assigned to the current assignee hereof and are fully incorporated herein by reference.

### FIELD OF THE INVENTION

The invention relates in general to controlling a distributed computing environment, and more particularly to methods for controlling a distributed computing environment running different applications or different portions of the same or different applications and data processing system readable media for carrying out the methods.

### DESCRIPTION OF THE RELATED ART

Internet websites provided by various businesses, government agencies, etc., can become increasingly complex as the various services offered and number of users increase. As they do so, the application infrastructures on which these websites are supported and accessed can also become increasingly complex, and transactions conducted via these websites can become difficult to manage and prioritize. In a typical application infrastructure, many more transactions related to information requests may be received compared to order placement requests. Conventional application infrastructures for websites may be managed by focusing more on the information requests because they greatly outnumber order placement requests. Consequently, merely placing an order at a website may become sluggish, and customers placing those orders can become impatient and not complete their order requests.

In another instance, some actions on the website can overpower an application infrastructure causing it to slow too much, or in some instances to crash. Therefore, all in-progress transactions being processed on the website may be lost. For example, during a holiday season, which may also correspond to a peak shopping season, an organization may allow users to upload pictures at the organization's website that is shared with other transactions, such as information requests for products or services of the organization and order placement requests. Because transmitting pictures over the Internet consumes a lot of resources, potential customers will find browsing and order placement too slow or the application infrastructure may crash during browsing or order placement. If those potential customers become frustrated from the slowness or crashing, the organization has lost potential revenue, which is undesired. Further, unknown, unintended, or unidentified transactions can consume too many resources relative to those transactions that deserve priority. Thus, any unknown or undefined transactions must be managed and controlled in addition to the known and defined transactions.

### SUMMARY

A distributed computing environment may be controlled by controlling flows, streams, and pipes used by applications within the distributed computing environment in a manner that is more closely aligned with the business objectives of the organization owning or controlling the distributed computing environment. A flow may be an aggregate set of packets having the same header, where the aggregate set of packets is transmitted from a particular physical component to another physical component. A stream lies at a higher level of abstraction and includes all of the flows associated with network traffic between two logical components, as opposed to physical components. A pipe is a physical network segment, and by analogy, is similar to a wire within cable.

The controls on each of the flows, streams, and pipes may include latency, priority, a connection throttle, and a network packet throttle. Parameters for determining the values for each of the controls may be based on any one or more of Virtual Local Area Network Identifier (VLAN ID), source address, destination address, source port, destination port, protocol, connection request, and transaction type load tag. In other embodiments, other parameters may be used.

By controlling the pipes and flows, traffic between physical components may be controlled to better achieve the business objectives of the organization and to substantially reduce the likelihood of (1) a lower priority transaction type (e.g., information requests) consuming too many resources compared to a higher priority transaction type (e.g., order placement), (2) a broadcast storm from a malfunctioning component, or (3) other similar undesired events that may significantly slow down the distributed computing environment or increase the likelihood that a portion or all of the distributed computing environment will crash.

As a physical component is provisioned, the controls for the pipes connected to that physical component are instantiated. Controls for the pipes are typically set at the entry point to the pipe. For example, if packets are being sent from a physical component (e.g., a managed host) to an appliance, the controls for the pipes and flows are set by a management agent residing on the physical component. In the reverse direction, the controls for the pipes and flows are set by the appliance (e.g., by a management blade within the appliance).

Controlling streams helps to provide better continuity of control as individual physical components, e.g., web servers, are being provisioned or de-provisioned within a logical component, e.g., the web server farm. The controls for the pipes, flows, and streams may be applied in a more coherent manner, so that the controls are effectively applied once rather than on a per pipe basis (in the instance when a flow passes through more than one pipe between the source and destination IP address) or on a per flow basis (in the instance when a stream includes flows where one of the flows is received by a different physical component compared to any of the other flows in the stream).

In one set of embodiments, a method of controlling a distributed computing environment includes examining at least one network packet associated with a stream or a flow. The method also includes setting a control for the flow, the stream, or a pipe based at least in part on the examination. In one embodiment, the control may include a priority, latency, a connection throttle, a network packet throttle, or any combination thereof.

In still another set of embodiments, data processing system readable media may comprise code that includes instructions for carrying out the methods and may be used in the distributed computing environment.

The foregoing general description and the following detailed description are only to illustrate and are not restrictive of the invention.

### BRIEF DESCRIPTION OF THE DRAWINGS

The present invention is illustrated by way of example and not limitation in the accompanying figures, in which the same reference number indicates similar elements in the different figures.

FIG. 1 includes an illustration of a hardware configuration of a system for managing and controlling an application that runs in an application infrastructure.

FIG. 2 includes an illustration of a hardware configuration of the application management and control appliance depicted in FIG. 1.

FIG. 3 includes an illustration of a hardware configuration of one of the management blades depicted in FIG. 2.

FIGS. 4-8 include an illustration of a process flow diagram for a method of controlling a distributed computing environment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A distributed computing environment may be controlled by controlling flows, streams, and pipes used by applications within the distributed computing environment in a manner that is more closely aligned with the business objectives of the organization owning or controlling the distributed computing environment. The controls on each of the flows, streams, and pipes may include latency, priority, a connection throttle, and a network packet throttle. Parameters for determining the values for each of the controls may be based on any one or more of Virtual Local Area Network Identifier (VLAN ID), source address, destination address, source port, destination port, protocol, connection request, and transaction type load tag. In other embodiments, other parameters may be used.

A few terms are defined or clarified to aid in an understanding of the terms as used throughout the specification.

The term “application” is intended to mean a collection of transaction types that serve a particular purpose. For example, a web site store front may be an application, human resources may be an application, order fulfillment may be an application, etc.

The term “application infrastructure” is intended to mean any and all hardware, software, and firmware within a distributed computing environment. The hardware may include servers and other computers, data storage and other memories, networks, switches and routers, and the like. The software used may include operating systems and other middleware components (e.g., database software, JAVA™ engines, etc.).

The term “component” is intended to mean a part within a distributed computing environment. Components may be hardware, software, firmware, or virtual components. Many levels of abstraction are possible. For example, a server may be a component of a system, a CPU may be a component of the server, a register may be a component of the CPU, etc. Each of the components may be a part of an application infrastructure, a management infrastructure, or both. For the purposes of this specification, component and resource may be used interchangeably.

The term “connection throttle” is intended to mean a control that regulates the number of connections in an application infrastructure. For example, a connection throttle may exist, for example, at a queue where connections are requested by multiple application infrastructure components. Further, the connection throttle may allow none, a portion, or all of the connections requests to be implemented.

The term “de-provisioning” is intended to mean that a physical component is no longer active within an application infrastructure. De-provisioning may include placing a component in an idling, maintenance, standby, or shutdown state or removing the physical component from the application infrastructure.

The term “distributed computing environment” is intended to mean a collection of components comprising at least one application, wherein different types of components reside on different network devices connected to the same network.

The term “flow” is intended to mean an aggregate set of network packets sent between two physical endpoints in an application infrastructure. For example, a flow may be a collection of network packets that are coming from one port at one Internet protocol (IP) address and going to another port at another IP address using a particular protocol.

The term “flow/stream mapping table” is intended to mean a table having one or more entries that correspond to predefined flows or streams. Each entry in a flow/stream mapping table may have one or more predefined characteristics to which actual flows or streams within an application infrastructure may be compared. Moreover, each entry in a flow/stream mapping table may have one or more predefined settings for controls. For example, a particular flow may substantially match a particular entry in a flow/stream mapping table and, as such, inherit the predefined control settings that correspond to that entry in the flow/stream mapping table.

The term “identification mapping table” is intended to mean a table having one or more entries that correspond to predefined characteristics based on one or more values of parameters. Each entry in an identification mapping table may have one or more predefined settings for controls. For example, a particular flow may substantially match a particular entry in an identification mapping table, and as such, inherit the predefined control settings that correspond to that entry in the identification mapping table.

The term “instrument” is intended to mean a gauge or control that may monitor or control at least part of an application infrastructure.

The term “latency” is intended to mean the amount of time it takes a network packet to travel from one application infrastructure component to another application infrastructure component. Latency may include a delay time before a network packet begins traveling from application infrastructure component to another application infrastructure component.

The term “logical component” is intended to mean a collection of the same type of components. For example, a logical component may be a web server farm, and the physical components within that web server farm may be individual web servers.

The term “logical instrument” is intended to mean an instrument that provides a reading reflective of readings from a plurality of other instruments. In many, but not all instances, a logical instrument reflects readings from physical instruments. However, a logical instrument may reflect readings from other logical instruments, or any combination of physical and logical instruments. For example, a logical instrument may be an average memory access time for a storage network. The average memory access time may be the average of all physical instruments that monitor memory access times for each memory device (e.g., a memory disk) within the storage network.

The term “network packet throttle” is intended to mean a control for regulating the delivery of network packets via an application infrastructure. For example, the network packet throttle may exist at a queue where network packets are waiting to be transmitted through a pipe. Moreover, the network packet throttle may allow none, a portion, or all of the network packets to be transmitted through the pipe.

The term “physical component” is intended to mean a component that serves a function even if removed from the distributed computing environment. Examples of physical components include hardware, software, and firmware that may be obtained from any one of a variety of commercial sources.

The term “physical instrument” is intended to mean an instrument for monitoring a physical component.

The term “pipe” is intended to mean a physical network segment between two application infrastructure components. For example, a network packet or a flow may travel between two application infrastructure components via a pipe.

The term “priority” is intended to mean the order in which network packets, flows, or streams are to be delivered via an application infrastructure.

The term “provisioning” is intended to mean that a physical component is in an active state within an application infrastructure. Provisioning includes placing a component in an active state or adding the physical component to the application infrastructure.

The term “stream” is intended to mean an aggregate set of flows between two logic components in a managed application infrastructure.

The term “transaction type” is intended to mean to a type of task or transaction that an application may perform. For example, browse request and order placement are transactions having different transaction types for a store front application.

As used herein, the terms “comprises,” “comprising,” “includes,” “including,” “has,” “having,” and any variations thereof, are intended to cover a non-exclusive inclusion. For example, a method, process, article, or appliance that comprises a list of elements is not necessarily limited to only those elements but may include other elements not expressly listed or inherent to such method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein may be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific networks, hardware, software, firmware components and acts are conventional and may be found in textbooks and other sources within the computer, information technology, and networking arts.

Before discussing embodiments of the present invention, a non-limiting, illustrative hardware architecture for using embodiments of the present invention is described. After reading this specification, skilled artisans will appreciate that many other hardware architectures may be used in carrying out embodiments described herein and to list every one would be nearly impossible.

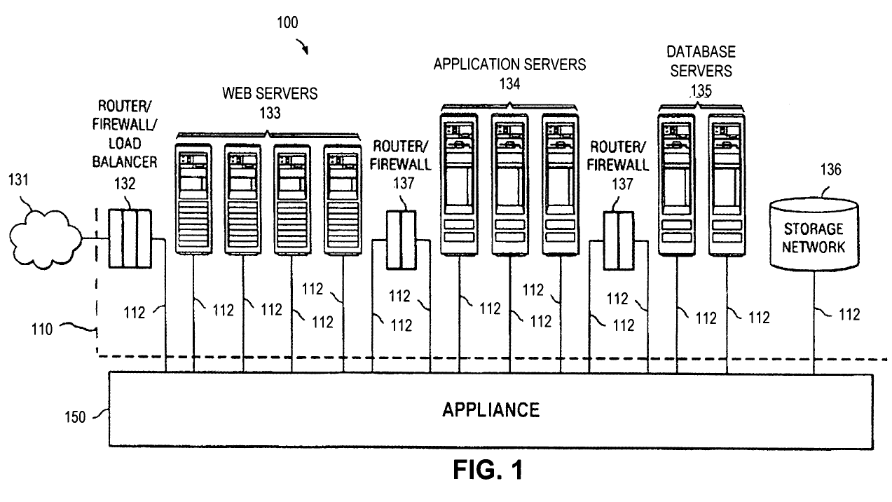

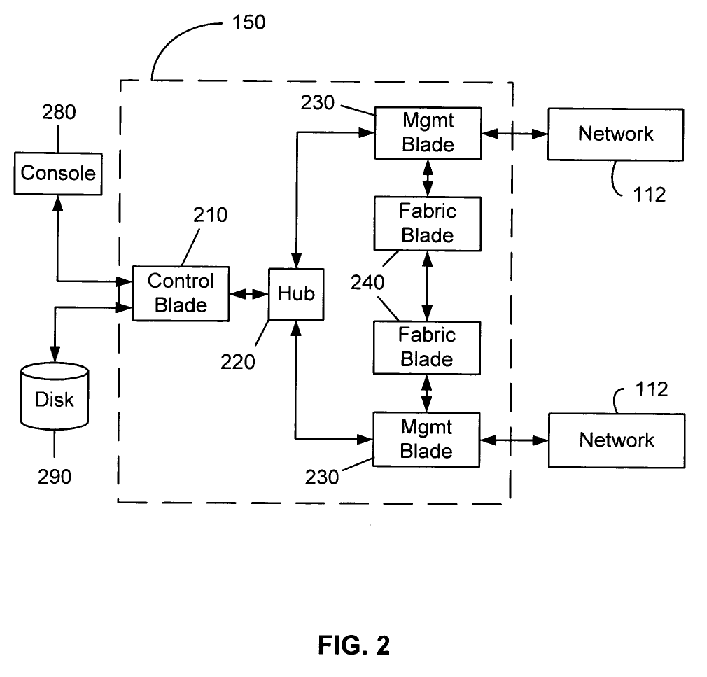

FIG. 1 includes a hardware diagram of a system 100. The system 100 includes an application infrastructure (A1), which includes management blades (seen in FIG. 2) and components above and to the right of the dashed line 110 in FIG. 1. The A1 includes the Internet 131 or other network connection, which is coupled to a router/firewall/load balancer 132. The A1 further includes Web servers 133, application servers 134, and database servers 135. Other computers may be part of the A1 but are not illustrated in FIG. 1. The A1 also includes storage network 136, router/firewalls 137, and network 112. Although not shown, other additional A1 components may be used in place of or in addition to those A1 components previously described. Each of the A1 components 132-137 is bi-directionally coupled in parallel to appliance (apparatus) 150 via network 112. The network 112 is connected to one or more network ports (not shown) of the appliance 150. In the case of router/firewalls 137, both the inputs and outputs from such router/firewalls are connected to the appliance 150. Substantially all the network traffic for A1 components 132-137 in A1 is routed through the appliance 150. Note that the network 112 may be omitted and each of components 132-137 may be directly connected to the appliance 150.

Software agents may or may not be present on each of A1 components 112 and 132-137. The software agents may allow the appliance 150 to monitor, control, or a combination thereof at least a part of any one or more of A1 components 112 and 132-137. Note that in other embodiments, software agents may not be required in order for the appliance 150 to monitor or control the A1 components.

In the embodiment illustrated in FIG. 1, the management infrastructure includes the appliance 150, the network 112, and software agents that reside on components 132-137.

FIG. 2 includes a hardware depiction of appliance 150 and how it is connected to other components of the system. The console 280 and disk 290 are bi-directionally coupled to a control blade 210 (central management component) within the appliance 150 using other ports (i.e., not the network ports coupled to the network 112). The console 280 may allow an operator to communicate with the appliance 150. Disk 290 may include data collected from or used by the appliance 150. The appliance 150 includes a control blade 210, a hub 220, management blades 230 (management interface components), and fabric blades 240. The control blade 210 is bi-directionally coupled to a hub 220. The hub 220 is bi-directionally coupled to each management blade 230 within the appliance 150. Each management blade 230 is bi-directionally coupled to the A1 and fabric blades 240. Two or more of the fabric blades 240 may be bi-directionally coupled to one another.

Although not shown, other connections may be present and additional memory may be coupled to each of the components within appliance 150. Further, nearly any number of management blades 230 may be present. For example, the appliance 150 may include one or four management blades 230. When two or more management blades 230 are present, they may be connected to different components within the A1. Similarly, any number of fabric blades 240. In another embodiment, the control blade 210 and hub 220 may be located outside the appliance 150, and nearly any number of appliances 150 may be bi-directionally coupled to the hub 220 and under the control of control blade 210.

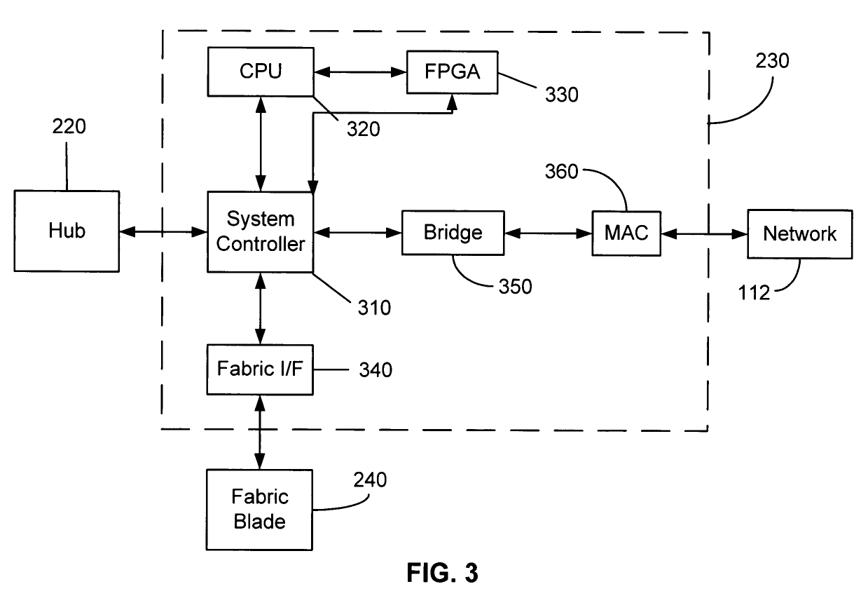

FIG. 3 includes an illustration of one of the management blades 230, which includes a system controller 310, central processing unit (“CPU”) 320, field programmable gate array (“FPGA”) 330, bridge 350, and fabric interface (“I/F”) 340, which in one embodiment includes a bridge. The system controller 310 is bi-directionally coupled to the hub 220. The CPU 320 and FPGA 330 are bi-directionally coupled to each other. The bridge 350 is bi-directionally coupled to a media access control (“MAC”) 360, which is bi-directionally coupled to the A1. The fabric I/F 340 is bi-directionally coupled to the fabric blade 240.

More than one of any or all components may be present within the management blade 230. For example, a plurality of bridges substantially identical to bridge 350 may be used and bi-directionally coupled to the system controller 310, and a plurality of MACs substantially identical to MAC 360 may be used and bi-directionally coupled to the bridge 350. Again, other connections may be made and memories (not shown) may be coupled to any of the components within the management blade 230. For example, content addressable memory, static random access memory, cache, first-in-first-out (“FIFO”) or other memories or any combination thereof may be bi-directionally coupled to FPGA 330.

The appliance 150 is an example of a data processing system. Memories within the appliance 150 or accessible by the appliance 150 may include media that may be read by system controller 310, CPU 320, or both. Therefore, each of those types of memories includes a data processing system readable medium.

Portions of the methods described herein may be implemented in suitable software code that may reside within or accessible to the appliance 150. The instructions in an embodiment of the present invention may be contained on a data storage device, such as a hard disk, magnetic tape, floppy diskette, optical storage device, or other appropriate data processing system readable medium or storage device.

In an illustrative embodiment of the invention, the instructions may be lines of assembly code or compiled C++, Java, or other language code. Other architectures may be used. For example, the functions of the appliance 150 may be performed at least in part by another appliance substantially identical to appliance 150 or by a computer, such as any one or more illustrated in FIG. 1. Some of the functions provided by the management blade(s) 230 may be moved to the control blade 210, and vice versa. After reading this specification, skilled artisans will be capable of determining which functions should be performed by each of the control and management blades 210 and 230 for their particular situations. Additionally, a computer program or its software components with such code may be embodied in more than one data processing system readable medium in more than one computer.

Attention is now directed to an exemplary, non-limiting embodiment of a method for controlling communication flows or streams in an application infrastructure (A1). The method may examine a flow or a stream, and based on the examination, set a particular control for the flow or stream. The classification may be based on a host of factors, including the application with which the communication is affiliated (including management traffic), the source or destination of the communication, and other factors, or any combination thereof.

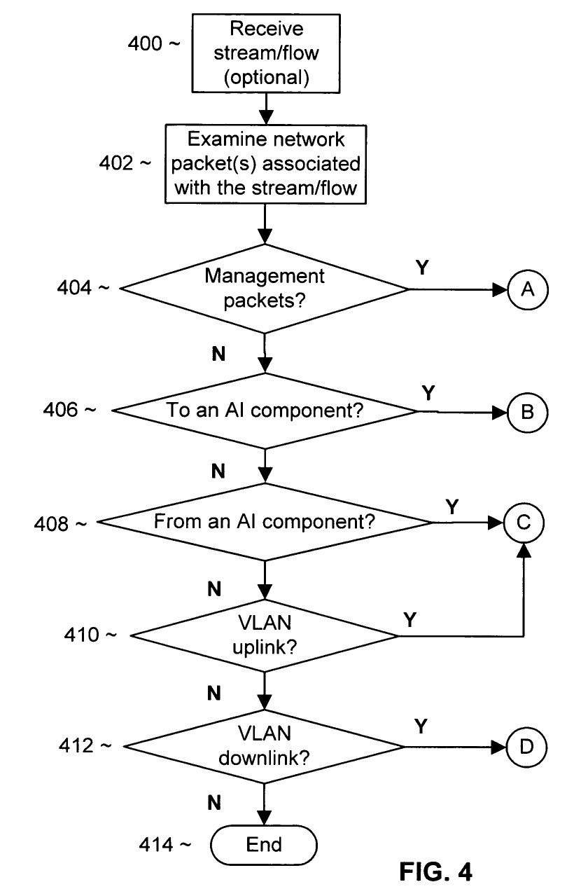

Referring now to FIG. 4 through FIG. 8, logic for controlling a distributed computing environment is illustrated and commences at block 400 wherein a stream or flow is received by the appliance 150 (FIGS. 1 and 2). As indicated in FIG. 4, this action is optional since some or all of the succeeding actions may be performed before a stream or flow is received by the appliance 150, (e.g., at a managed A1 component). At block 402, network packets associated with a stream or flow are examined. The network packets are examined in order to identify the flows or streams in which they are found. Several parameters may be used in order to identify the flows or streams. These parameters may include virtual local area network identification, source address, destination address, source port, destination port, protocol, connection request, and transaction type load tag. The source and destination addresses may be IP addresses or other network addresses, e.g., 1×250srv. These parameters may exist within the header of each network packet. Moreover, the connection request may be a simple “yes/no” parameter (i.e., whether or not the packet represents a connection request). Also, the transaction type load tag may be used to define the type of transaction related to a particular flow or stream. The transaction type load tag may be used to provide for more fine-grained control over application or transaction type-specific network flows.

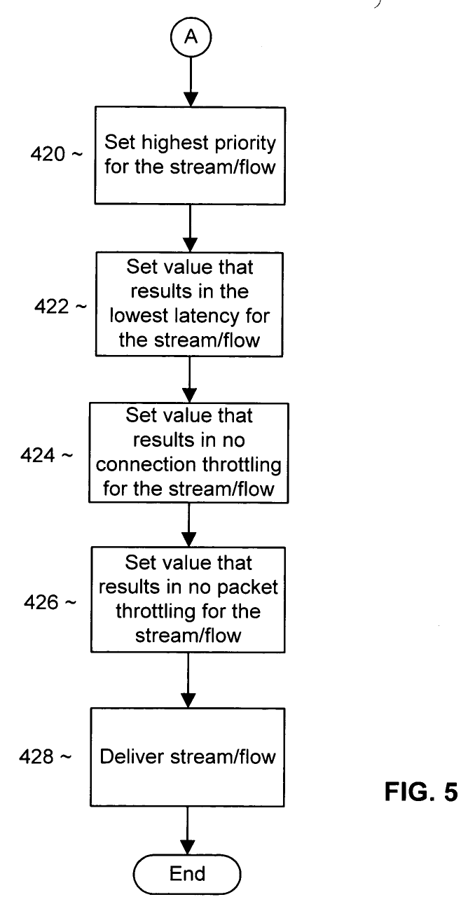

At decision diamond 404, a determination is made whether the network packets are management packets. If the network packets are management packets, they are processed as illustrated in FIG. 5. As depicted in FIG. 5, at block 420, the highest priority is set for the stream or flow. Next, at block 422, the value that results in the lowest latency is set for the stream, the flow, or both. At block 424, the value that results in no connection throttling is set for the stream, the flow, or both. And, at block 426, the value that results in no packet throttling is set for the stream, the flow, or both.

In an exemplary, non-limiting embodiment, the settings for priority are simply based on a range of corresponding numbers, e.g., zero to seven (0-7), where zero (0) is the lowest priority and seven (7) is the highest priority. Further, the range for latency may be zero or one (0 or 1), where zero (0) means drop network packets with normal latency and one (1) means drop network packets with high latency. Also, the range for the connection throttle may be from zero to ten (0-10), where zero (0) means throttle zero (0) out of ten (10) connection requests (i.e., zero throttling) and ten (10) means throttle ten (10) out of every ten (10) connection requests (i.e., complete throttling). The range for network packet throttle may be substantially the same as the range for the connection throttle. The above ranges are exemplary and there may exist numerous other ranges of settings for priority, latency, connection throttle, and network packet throttle. Moreover, the settings may be represented by nearly any group of alphanumeric characters.

Proceeding to block 428, the stream or flow is delivered with the above settings in effect. Accordingly, any network packets that are management packets sent to a managed A1 component by the management blade 230 (FIGS. 2 and 3) of the appliance 150 (FIGS. 1 and 2) are afforded special treatment by the system (FIG. 1) and are delivered expeditiously through the system 100 (FIG. 1). Moreover, any management network packets that are received by the appliance 150 (FIGS. 1 and 2) from a managed A1 component are also afforded special treatment by the system 100 (FIG. 1) and are also expeditiously delivered through the system 100 (FIG. 1).

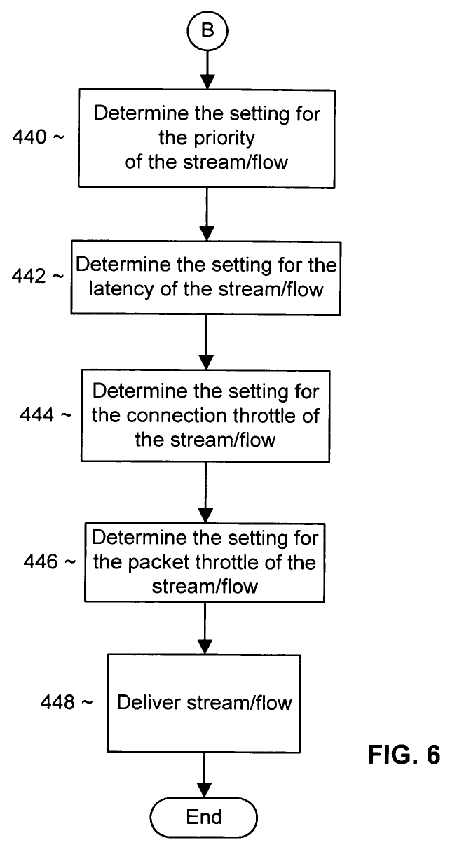

Returning to the logic shown in FIG. 4, if the network packets associated with a particular stream or flow are not management packets, as determined at decision diamond 404, the logic moves to decision diamond 406 and a determination is made regarding whether the network packets are to be delivered to an A1 component from the management blade 230 (FIGS. 2 and 3) within the appliance 150 (FIGS. 1 and 2). If yes, the stream or flow that includes those network packets are processed as depicted in FIG. 6. At block 440, depicted in FIG. 6, the setting for the priority of the stream or flow is determined. Moving to block 442, the setting for the latency of the stream or flow is determined. Next, at block 444 the setting for the connection throttle of the stream or flow is determined. And, at block 446, the setting for the network packet throttle of the stream or flow is determined.

In an exemplary, non-limiting embodiment, the above-described settings may be determined by comparing the network packets comprising a flow or stream to an identification table in order to identify that particular flow or stream. Once identified, the control settings for the identified flow or stream may be determined based in part on the identification table. Or, the identified flows or streams may be further compared to a flow/stream mapping table in order to determine the values for the control settings. The control settings can be applied to a flow and a stream or just a flow and not a stream. At block 448, the stream or flow is delivered according to the above-determined settings.

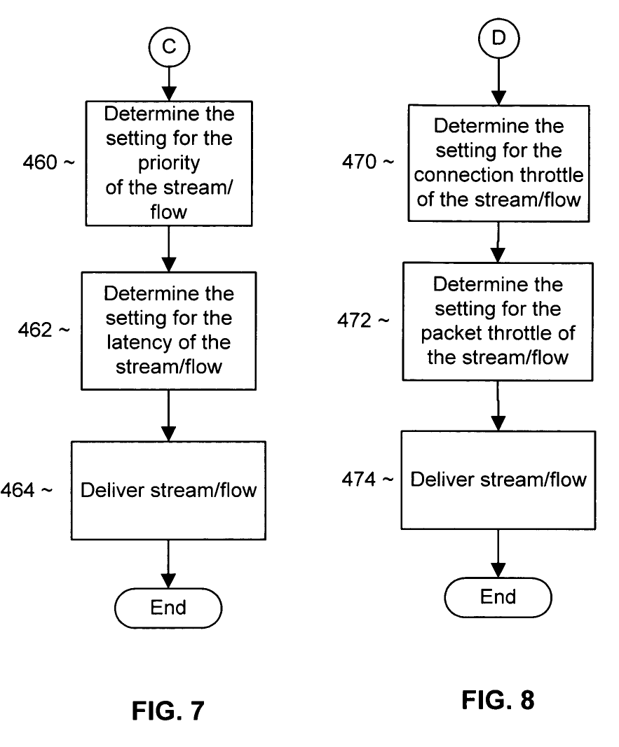

Again, returning to the logic shown in FIG. 4, at decision diamond 406, if the network packets associated with a particular stream or flow are not being sent to an A1 component, the logic continues to decision diamond 408. At decision diamond 408, a determination is made regarding whether the network packets are being sent from an A1 component to the appliance 150. If yes, those network packets are processed as illustrated in FIG. 7. Referring to FIG. 7, at block 460, the setting for the priority of the stream or flow is determined. Thereafter, the setting for the latency of the stream or flow is determined at block 462. These settings may be determined as discussed above. At block 464, the stream or flow is delivered according to the settings determined above.

At decision diamond 408 depicted in FIG. 4, if the network packets are not being delivered to an A1 component, the logic continues to decision diamond 410. At decision diamond 408, a determination is made regarding whether the network packets are being delivered via a virtual local area network uplink. If so, the network packets are processed as shown in FIG. 7, described above. On the other hand, if the network packets are not being delivered via a VLAN uplink, the logic proceeds to decision diamond 412, and a determination is made concerning whether the network packets are being delivered via a VLAN downlink. If so, the network packets are processed as shown in FIG. 8. At block 470, depicted in FIG. 8, the setting for the connection throttle of the stream or flow is determined. Then, at block 472, the setting for the network packet throttle of the stream or flow is determined. At block 474, the stream or flow is delivered. Returning to decision diamond 412, portrayed in FIG. 4, if the network packets are not being delivered via a VLAN downlink, the logic ends at state 414.

In the above-described method, the controls that are provided (i.e., priority, latency, connection throttle, and network packet throttle), are used to control the components that make up one or more pipes. In an exemplary, non-limiting embodiment, a pipe may be a link between a managed A1 component and a management blade 230 (FIGS. 2 and 3). A pipe may be a link between a management blade 230 (FIGS. 2 and 3) and a managed A1 component. Further, a pipe may be a VLAN uplink or VLAN downlink. A pipe may be a link between a control blade 210 (FIG. 2) and a management blade 230 (FIGS. 2 and 3). Moreover, a pipe may be a link between two management blades 230 (FIGS. 2 and 3) or an appliance backplane.

It can be appreciated that, in the above-describe method, some or all of the actions may be undertaken at different locations within the system I 00 (FIG. I) in order to provide controls on the pipes. For example, when a flow or stream is to be delivered to a managed A1 component from a management blade 230 (FIGS. 2 and 3), latency, priority, connection throttling, and network packet throttling can be implemented on the management blade 230 (FIGS. 2 and 3), e.g., through the FPGA 339 (FIG. 3) or on software operating on a switching control processor (not shown) within the management blade 230 (FIGS. 2 and 3). On the other hand, when a flow or stream is coming to a management blade 230 (FIGS. 2 and 3) from a managed A1 component, latency and priority can be implemented on the managed A1 component. In an exemplary, non-limiting embodiment, a communication mechanism can exist between the control blade 210 (FIG. 2) and a software agent at the managed A1 component in order to inform the software agent the values that are necessary for latency and priority. Further, a mechanism can exist at the software agent in order to implement those settings at the network layer.

Depending on which direction a flow or stream is traveling, e.g., to or from a managed A1 component, connection throttling and/or network packet throttling can occur at the management blade 230 (FIGS. 2 and 3) or at the managed A1 component. Since it may be difficult to retrieve a flow or stream once it has been sent into a pipe, in one embodiment, connection throttling can be implemented at the component from which a stream or flow originates.

Further, in an exemplary, non-limiting embodiment, when a flow or stream is being delivered via a VLAN uplink, the latency and priority controls can be implemented on the management blade 230 (FIGS. 2 and 3). Also, in an exemplary, non-limiting embodiment, when a flow or stream is being delivered via a VLAN downlink, the connection throttle and the network packet throttle can also be implemented on the management blade.

During configuration of the system 100 (FIG. I), streams and flows can be defined and created for each application, transaction type, or both in the system 100. For each managed A1 component, the necessary pipes are also defined and created. Moreover, for each uplink or downlink in each VLAN, the necessary pipes are created.

During operation, the provisioning and de-provisioning of certain A1 components, e.g., servers, can have an impact on the system 100 (FIG. 1). For example, when a server is provisioned, the provisioned server can result in the creation of one or more flows, therefore, a mechanism can be provided to scan the identification mapping table and to create new entries as necessary. In addition, the provisioned server can result in the creation of a new pipe. When a server is de-provisioned, the de-provisioned server can cause one or more flows to be unnecessary. Therefore, a mechanism can be provided to scan the identification mapping table and delete the unnecessary entries as necessary. Any pipes associated with the de-provisioned server can also be removed.

If a managed A1 component is added, corresponding flows and pipes can be created. This can include management flows to and from the management blade 230 (FIGS. 2 and 3). Conversely, if a managed A1 is removed, the corresponding flows and pipes can be deleted. This also includes the management flows to and from the management blade 230 (FIGS. 2 and 3) within the appliance 150 (FIGS. 1 and 2). Further, if an uplink is added for a VLAN, the corresponding pipes can be created. On the other hand, if an uplink is removed for a VLAN, the corresponding pipes can be deleted. With the provisioning and de-provisioning of A1 components and the addition and removal of managed A1 components, the identification mapping table can be considered dynamic during operation (i.e., entries are created and removed as A1 components) are provisioned and de-provisioned and as managed A1 components are added and removed.

In one exemplary, non-limiting embodiment, a number of flows within the system 100 may cross network devices that are upstream of a management blade 230 (FIGS. 2 and 3). Further, the priority and latency settings that are established during the execution of the above-described method can have an influence on the latency and priority of those affected packets as they cross any upstream devices. As such, the hierarchy established for priority can be based on a recognized standard, e.g., the IEEE 802.1p/802.1q standards. Additionally, when connection requests are refused, or lost, the requestor may employ an exponential back-off mechanism before re-trying the connection request. Thus, in an exemplary, non-limiting embodiment, the connection throttle can throttle connection requests in whatever manner is required to invoke the standard request back-off mechanism.

The above-described method can be used to control the delivery of flows and streams along pipes to and from managed A1 components within a distributed computing environment. Depending on the direction of travel of a particular flow or stream, some or all of the controls can be implemented at the beginning or end of each pipe. Further, by controlling a distributed computing environment using the method describe above, the efficiency and quality of service of data transfer via the distributed computing environment can be increased.

Note that not all of the activities described in FIG. 4 through FIG. 8 are necessary, that an element within a specific activity may not be required, and that further activities may be performed in addition to those illustrated. Additionally, the order in which each of the activities is listed is not necessarily the order in which they are performed. After reading this specification, a person of ordinary skill in the art will be capable of determining which activities and orderings best suit any particular objective.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method of controlling a distributed computing environment comprising:
examining a network packet associated with a stream or a flow; and
setting a control for the flow, the stream, or a pipe based at least in part on the examination.

2. The method of claim 1, wherein examining comprises examining a parameter of the network packet.

3. The method of claim 2, wherein the parameter comprises a virtual local area network identification, a source address, a destination address, a source port, a destination port, a protocol, a connection request, a transaction type load tag, or any combination thereof.

4. The method of claim 2, further comprising associating the network packet with one of a set of specific flows/streams at least partially based on the parameter.

5. The method of claim 4, wherein associating the network packet comprises using an identification mapping table, wherein an entry in the identification mapping table maps the network packet to a specific flow/stream.

6. The method of claim 5, wherein each entry in the identification mapping table is mapped to an entry in a flow/stream mapping table.

7. The method of claim 6, wherein each entry in the identification mapping table or the flow/stream mapping table includes values for settings for priority, latency, a connection throttle, a network packet throttle, and a combination thereof.

8. The method of claim 2, further comprising determining a value of the setting based at least in part on the value of the parameter.

9. The method of claim 8, wherein setting the control is applied once to the flow or the stream, regardless of a number of pipes used for the flow or the stream.

10. The method of claim 8, wherein the value of the setting is obtained from a flow entry and not a stream entry of a table.

11. An appliance for carrying out the method of claim 1.

12. A data processing system readable medium having code for controlling a distributed computing environment, wherein the code is embodied within the data processing system readable medium, the code comprising:
an instruction for examining a network packet associated with a stream or a flow; and
an instruction for setting a control for the flow, the stream, or a pipe based at least in part on the examination.

13. The data processing system readable medium of claim 12, wherein the instruction for examining comprises examining a parameter of the network packet.

14. The data processing system readable medium of claim 13, wherein the parameter includes a virtual local area network identification, a source address, a destination address, a source port, a destination port, a protocol, a connection request, a transaction type load tag, or any combination thereof.

15. The data processing system readable medium of claim 13, further comprising an instruction for associating the network packet with one of a set of specific flows/streams at least partially based on the parameter.

16. The data processing system readable medium of claim 15, wherein the instruction for associating the network packet comprises using an identification mapping table, wherein an entry in the identification mapping table maps the network packet to a specific flow/stream.

17. The data processing system readable medium of claim 16, wherein each entry in the identification mapping table is mapped to an entry in a flow/stream mapping table.

18. The data processing system readable medium of claim 17, wherein each entry in the identification mapping table or the flow/stream mapping table includes values for settings for priority, latency, a connection throttle, a network packet throttle, and a combination thereof.

19. The data processing system readable medium of claim 13, further comprising an instruction for determining a value of the setting based at least in part on the value of the parameter.

20. The data processing system readable medium of claim 19, wherein setting the control is applied once to the flow or the stream, regardless of a number of pipes used for the flow or the stream.

21. The data processing system readable medium of claim 19, wherein the value of the setting is obtained from a flow entry and not a stream entry of a table.
